(19) United States
(12) Patent Application Publication
(10) Pub. No.: US 2012/0007549 A1
(43) Pub. Date: Jan. 12, 2012

(54) WIRELESS CHARGING DEVICE AND WIRELESS CHARGING SYSTEM

(75) Inventors: Yuji Murayama, Tokyo (JP); Kenichi Fujimaki, Kanagawa (JP)

(73) Assignee: SONY CORPORATION, Tokyo (JP)

(21) Appl. No.: 13/155,461

(22) Filed: Jun. 8, 2011

(30) Foreign Application Priority Data
Jul. 9, 2010 (JP) 2010-157183

(51) Int. Cl. H02J 7/00

(52) U.S. Cl. 320/108

(57) ABSTRACT

Disclosed herein is a wireless charging device including: a feeding device capable of feeding power on a wireless basis; and a display device, the feeding device including a power generating section configured to generate the power to be fed, a power transmitting element section configured to transmit the power generated by the power generating section, and a wireless communicating section capable of wireless data transmission and reception, and the display device being capable of displaying at least one of data transferred from a charging object device and received through the wireless communicating section and information on charging conditions, the information on the charging conditions being received as a response to the power transmitted for charging.

### BACKGROUND

The present disclosure relates to a wireless charging device of a noncontact feeding system and a wireless charging system capable of supplying power to an electronic device such as a portable telephone or the like including a secondary battery (battery) on a noncontact (wireless) basis.

Until now, mobile devices (electronic devices) such as a portable telephone, a digital camera, a portable music player, a smart phone and the like are each connected to a dedicated power cable or a dedicated AC (Alternating Current) adapter to charge a battery serving as a power supply.

Japanese Patent Laid-Open No. 2008-258826 discloses a technique in which an image display device is added to a cradle for placing and charging a camera as an electronic device, image data is received from the camera via a contact, and the camera is charged also via a contact.

### SUMMARY

However, mobile devices are troublesome because mobile devices are each connected to a separate power cable or a separate AC adapter to be charged. Each time a mobile device is added or each time a new mobile device is bought, the number of chargers is increased, so that it becomes difficult to distinguish and manage the mobile devices.

It is desirable to provide a wireless charging device and a wireless charging system that make it possible to perform both charging and data transfer simultaneously and in parallel with each other without any cable connection by merely placing an electronic device at a distance at which the charging device can transmit power, which thereby eliminate the trouble of preparing separate chargers, and which are thus highly convenient.

According to a first viewpoint of the present disclosure, there is provided a wireless charging device including: a feeding device capable of feeding power on a wireless basis; and a display device. The feeding device includes a power generating section configured to generate the power to be fed, a power transmitting element section configured to transmit the power generated by the power generating section, and a wireless communicating section capable of wireless data transmission and reception. The display device is capable of displaying at least one of data transferred from a charging object device and received through the wireless communicating section and information on charging conditions, the information on the charging conditions being received as a response to the power transmitted for charging.

According to a second viewpoint of the present disclosure, there is provided a wireless charging system including: a wireless charging device capable of transmitting power for charging on a wireless basis; and an electronic device including a battery and a power receiving device, the power receiving device being capable of receiving the power of the wireless charging device and charging the battery. The wireless charging device includes a feeding device capable of feeding the power on a wireless basis and a display device. The feeding device includes a power generating section configured to generate the power to be fed, a power transmitting element section configured to transmit the power generated by the power generating section, and a first wireless communicating section capable of wireless data transmission and reception to and from the electronic device. The power transmitting element section includes a first resonance coil for transmitting the power. The display device is capable of displaying at least one of data transferred from the electronic device and received through the first wireless communicating section and information on charging conditions, the information on the charging conditions being received as a response to the power transmitted for charging. The power receiving device of the electronic device includes a power receiving element section including a second resonance coil for receiving the power while having a magnetic field resonance relation to the first resonance coil of the feeding device, an information obtaining section configured to obtain the information on the charging conditions, and a second wireless communicating section capable of wireless data transmission and reception to and from the wireless charging device, and capable of transmitting the information on the charging conditions, the information on the charging conditions being obtained by the information obtaining section, on a wireless basis as the response to the power received for charging from the wireless charging device.

According to the present disclosure, advantages are provided in that both charging and data transfer can be performed simultaneously and in parallel with each other without any cable connection by merely placing an electronic device at a distance at which a charging device can transmit power, the trouble of preparing separate chargers is thereby eliminated, and thus a high degree of convenience is provided.

### BRIEF DESCRIPTION OF THE DRAWINGS

FIG. 1 is a diagram showing an example of constitution of the whole of a wireless charging system according to an embodiment of the present disclosure;

FIG. 2 is a block diagram showing an example of basic configuration of a power transmitting system of the wireless charging system according to the embodiment of the present disclosure;

FIG. 3 is a block diagram showing an example of basic configuration of a power receiving system of the wireless charging system according to the embodiment of the present disclosure;

FIG. 4 is a diagram schematically showing relation between a power transmitting side coil and a power receiving side coil of the wireless charging system according to the embodiment of the present disclosure;

FIGS. 5A and 5B are diagrams showing a first example of constitution of a charging device having a charging stand in which the power transmitting coil according to the present embodiment is disposed and on which an electronic device can be placed;

FIG. 6 is a diagram showing a second example of constitution of the charging device having the charging stand in which the power transmitting coil according to the present embodiment is disposed and on which the electronic device can be placed;

FIGS. 7A and 7B are diagrams showing a third example of constitution of the charging device having the charging stand in which the power transmitting coil according to the present embodiment is disposed and on which the electronic device can be placed;

FIGS. 8A and 8B are diagrams showing a fourth example of constitution of the charging device having the charging stand in which the power transmitting coil according to the present embodiment is disposed and on which the electronic device can be placed;

FIGS. 9A and 9B are diagrams showing a fifth example of constitution of the charging device having the charging stand in which the power transmitting coil according to the present embodiment is disposed and on which the electronic device can be placed;

FIG. 10 is a diagram showing an example of configuration of a feeding device of the charging device having a feeding function and a data transmitting and receiving function according to the present embodiment;

FIG. 11 is a diagram showing an example of configuration of a power receiving device of the electronic device having a power receiving function and a data transmitting and receiving function according to the present embodiment;

FIG. 12 is a flowchart of assistance in explaining an operation of the wireless charging system when performing authentication and charging;

FIG. 13 is a diagram showing an example of display of a state of charge of the electronic device as a charging object on the display screen of a photo frame as an example of the charging device;

FIG. 14 is a diagram showing a voltage-current characteristic at a time of charging of a battery (secondary battery);

FIG. 15 is a diagram showing a system for detecting a voltage and a current at a time of charging of the battery (secondary battery) in the power receiving device;

FIG. 16 is a diagram showing a known charging characteristic recorded in a memory on the side of the electronic device as a table;

FIG. 17 is a first flowchart of assistance in explaining an operation of displaying charging conditions; and

FIG. 18 is a second flowchart of assistance in explaining the operation of displaying the charging conditions.

### DETAILED DESCRIPTION OF PREFERRED EMBODIMENTS

Preferred embodiments of the present disclosure will hereinafter be described with reference to the drawings.

Incidentally, description will be made in the following order.

1. Basic Configuration of Wireless Charging System

2. Basic Configuration of Feeding Section of Wireless Charging Device

3. Basic Configuration of Wireless Power Receiving

Device

4. Basic Operation of Wireless Charging System

5. Examples of Structure in which Power Transmitting Coil is Disposed on Charging Device Side

6. Example of Constitution of Feeding Device and Power Receiving Device of Wireless Charging System Performing Authentication

7. Operation of Wireless Charging System when Performing Authentication and Charging

8. Example of Display of State of Battery Charge in Charging Object Device on Charging Device Side

9. Mechanism for Displaying Charging Conditions on Screen of Photo Frame as Example of Charging Device

10. Operation of Displaying Charging Conditions

### <1. Basic Configuration of Wireless Charging System>

FIG. 1 is a diagram showing an example of constitution of the whole of a wireless charging system according to an embodiment of the present disclosure.

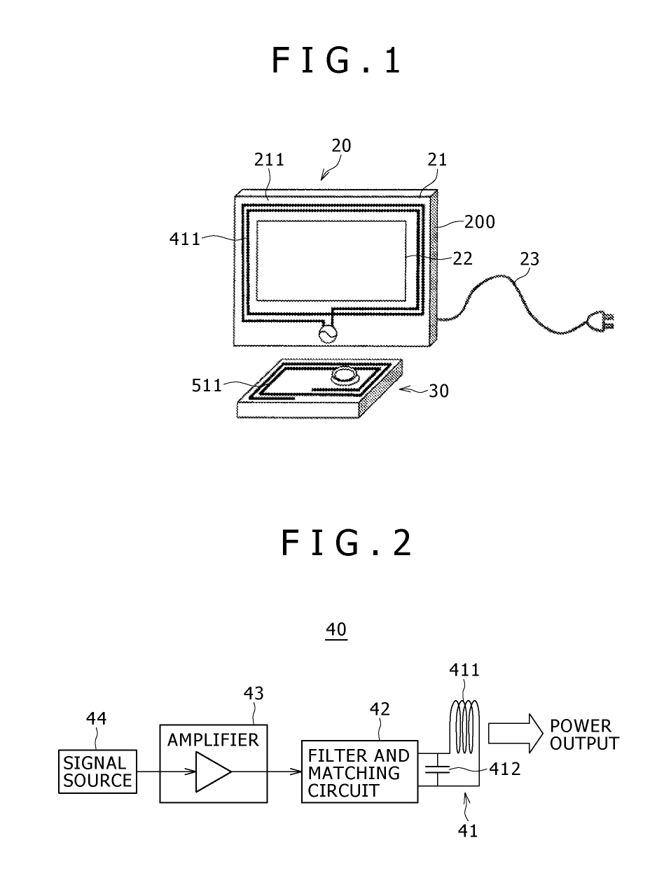

FIG. 2 is a block diagram showing an example of basic configuration of a power transmitting system of the wireless charging system according to the embodiment of the present disclosure.

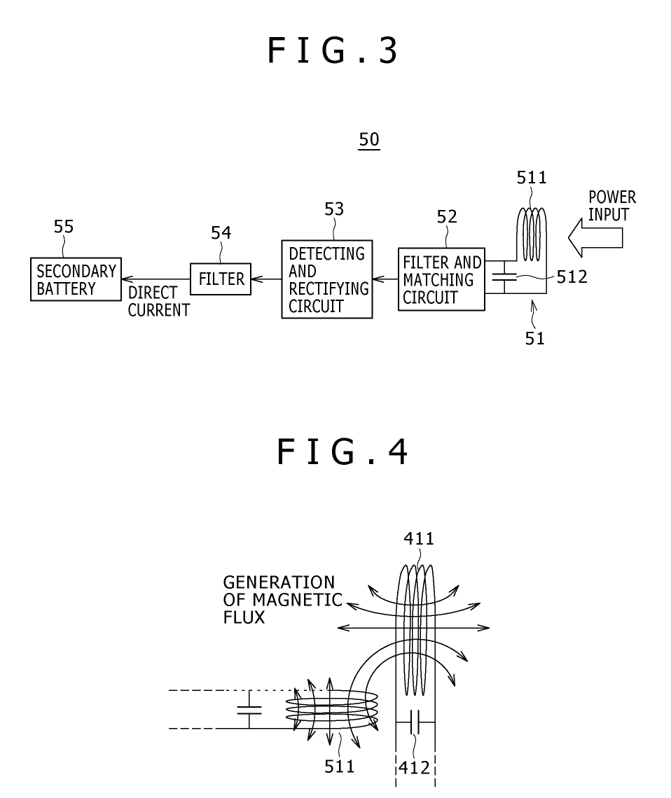

FIG. 3 is a block diagram showing an example of basic configuration of a power receiving system of the wireless charging system according to the embodiment of the present disclosure.

FIG. 4 is a diagram schematically showing relation between a power transmitting side coil and a power receiving side coil of the wireless charging system according to the embodiment of the present disclosure.

The present wireless charging system 10 has a wireless charging device 20 having a display function and a radio communicating function and an electronic device (portable device) 30 including a wireless power receiving device.

The wireless charging device (hereinafter referred to as a charging device) 20 is formed by a photo frame 200 that displays digital image data obtained by image pickup with a digital camera, for example.

The charging device 20 basically has a rectangular casing 21 as a device main body, a display device 22 such as a liquid crystal display (LCD) or the like disposed in a central part of the casing 21, and a power cable 23.

The charging device 20 in FIG. 1 has a feeding device such as a power transmitting coil (resonance coil) or the like disposed in an outer frame part 211 of the casing 21 to perform wireless (radio or noncontact) feeding of power for charge to the electronic device 30 disposed at a distance where power transmission is possible.

As will be described later, the charging device 20 has a function of performing authentication with the electronic device 30 on a wireless (radio) basis.

In addition, the charging device 20 can transmit and receive digital data such as image data or the like to and from the electronic device 30.

For example, as will be described later, the charging device 20 has a function of displaying information on charge, such as the progress of charging of a battery in the electronic device 30 as a charging object in percentage terms (charging rate), a time remaining until full charge, charge completion, and the like, on the display device 22.

The electronic device 30 is formed by a portable device such as a digital camera, a portable telephone or the like. The electronic device 30 includes a battery, which is a secondary battery.

The electronic device 30 is supplied with power from the charging device 20 on a wireless basis. The electronic device 30 receives the power, and performs rectification, detection and the like. The electronic device 30 supplies the received power to the battery as a load.

The wireless power receiving device of the electronic device 30 can transmit and receive digital data such as image data or the like to and from the charging device 20.

For example, as will be described later, the wireless power receiving device has a function of transmitting information on charge, such as the progress of charging of the battery in percentage terms (charging rate), a time remaining until full charge, charge completion, and the like, on a wireless basis.

Description will next be made of a feeding device 40 in the charging device 20 and a power receiving device 50 in the electronic device 30 applied to the above wireless charging system 10.

### <2. Basic Configuration of Feeding Section of Wireless Charging Device>

The feeding device 40 has a power transmitting element section 41, a filter and matching circuit 42, an amplifier 43, and a signal source 44 for generating high-frequency power as a power generating section.

The power transmitting element section 41 includes a first resonance coil (power transmitting coil) 411 as a resonant element and a capacitor 412. The power transmitting element section 41 has a resonant circuit formed by the resonance coil 411 and the capacitor 412.

In the example of FIG. 1, the resonance coil 411 is disposed in the outer frame part 211 of the casing 21.

In addition, the power transmitting element section 41 may have a feeding coil as a feeding element disposed therein.

The resonance coil 411 is set in a magnetic field resonance relation and transmits power efficiently when the self-resonant frequency of the resonance coil 411 coincides with that of a resonance coil 511 of the power receiving device 50.

The matching circuit 42 has a function of impedance matching at a feeding point of the resonance coil 411. The matching circuit 42 adjusts impedance so as to be able to transmit power efficiently.

The amplifier 43 subjects a power signal generated by the signal source 44 to power amplification, and supplies the result to the matching circuit 42.

The signal source 44 generates high-frequency power for wireless power transmission.

Because it is desirable for the signal source 44 to generate the high-frequency power with high efficiency, a switching amplifier or the like is used as the signal source 44.

The high-frequency power of the signal source 44 is fed (applied) to the resonance coil 411 of the power transmitting element section 41 via the amplifier 43 and the matching circuit 42.

### <3. Basic Configuration of Wireless Power Receiving Device>

The power receiving device 50 includes a power receiving element section 51, a filter and matching circuit 52, a detecting and rectifying circuit 53, a filter 54, and a battery 55 as a load.

The power receiving element section 51 includes a second resonance coil (power receiving coil) 511 as a resonant element and a capacitor 512. The power receiving element section 51 has a resonant circuit formed by the resonance coil 511 and the capacitor 512.

The resonance coil 511 receives an alternating current magnetic field, and generates an electromotive force.

The resonance coil 511 is set in a magnetic field resonance relation and receives power efficiently when the self-resonant frequency of the resonance coil 511 coincides with that of the resonance coil 411 of the feeding device 40.

The matching circuit 52 has a function of impedance matching at a part of connection (load terminal) with the load of the resonance coil 511. The matching circuit 52 adjusts impedance so as to be able to receive power efficiently.

The detecting and rectifying circuit 53 rectifies the received alternating-current power, and supplies the rectified power as direct-current (DC) power to the filter 54.

The filter 54 converts the DC power supplied from the detecting and rectifying circuit 53 to a DC voltage according to the specifications of the electronic device as a supply destination, and supplies the stabilized DC voltage to the battery 55 as the load of the electronic device. The filter 54 thus functions as a voltage stabilizing circuit.

### <4. Basic Operation of Wireless Charging System>

In the wireless charging system 10 according to the present embodiment, the resonance coil (power transmitting coil) 411 of the feeding device 40 is incorporated (disposed) in the outer frame part 211, which is the frame periphery of the photo frame as the charging device 20, so as to surround the peripheral part of the display device 22.

In addition, the resonance coil (power receiving coil) 511 of the power receiving device 50 is incorporated (disposed) in the inside on one surface side of the electronic device 30 such as a digital camera, for example.

In the feeding device 40 included in the charging device 20, a signal of a predetermined frequency from the signal source 44 is subjected to power amplification by the amplifier 43 as shown in FIG. 2, for example.

The amplified power is supplied to the resonance coil (power transmitting coil) via the matching circuit 42. Thereby, an alternating current is fed, and an alternating-current magnetic field is generated, whereby the power is transmitted on a wireless basis.

On the side of the electronic device 30, the resonance coil (power receiving coil) 511 receives the alternating-current magnetic field and generates an electromotive force, and the electromotive force is supplied to the detecting and rectifying circuit 53 through the matching circuit 52. The detecting and rectifying circuit 53 converts an alternating current into a direct current to charge the battery 55 through the filter 54.

Thus, in the present embodiment, resonant circuits are formed by combining the resonance coils of the photo frame as the charging device 20 and the digital camera with capacitors, and the power transmission of a magnetic field resonance system is made.

Thereby, the efficiency of power transmission is not decreased so much even when the positions of the two resonance coils 411 and 511 are distant from each other, or even when the central axes of the coils do not coincide with each other.

As described above, in the present wireless charging system 10, power is transmitted from the power transmitting coil of the feeding device 40 to the power receiving coil of the electronic device 30 such as a digital camera or the like, and the electronic device 30 can be charged without a cable by merely placing the electronic device 30 beside the photo frame.

At this time, resonant circuits are formed by coils and capacitors, and the wireless power transmission of a magnetic field resonance system is made. Thereby, even when the power transmitting coil and the power receiving coil do not face each other, but are positioned at a certain angle with each other, as shown in FIG. 4, a magnetic flux concentrates in the power receiving coil, and thus power can be transmitted with high efficiency.

Even when the electronic device 30 is not only a digital camera but also a portable telephone, a portable music player, a smart phone or the like, the electronic device 30 can be charged by merely placing the electronic device 30 beside the photo frame as an example of the charging device 20 when the power receiving coil is incorporated into the electronic device 30. Thus, the user of the electronic device does not need to prepare a separate charger.

Incidentally, simultaneously and in parallel with the charging, a photograph data file within the digital camera or the portable telephone can be transferred to the photo frame by a function of radio communication of a wireless LAN, Bluetooth, ZigBee or the like to display an image in the photo frame.

Thus, by merely placing the electronic device 30 as a mobile device beside the charging device 20 such as the photo frame or the like, both charging and the transfer of image data can be performed simultaneously and in parallel with each other without any cable connection, and the trouble of preparing a separate charger is eliminated.

<5. Examples of Structure in which Power Transmitting Coil is Disposed on Charging Device Side>

With the constitution of FIG. 1, in the photo frame forming the charging device 20, the resonance coil (power transmitting coil) 411 of the feeding device 40 is incorporated (disposed) in the outer frame part 211 as a frame periphery so as to surround the peripheral part of the display device 22.

In this example, charging and data transfer are performed by placing the electronic device 30 as an object of charging and data transfer (communication) beside the photo frame.

On the other hand, as will be shown in the following, constitutions serving as a charging stand in which the resonance coil (power transmitting coil) 411 is disposed and which functions as a stand for mounting the electronic device 30 can be adopted. By adopting the constitutions, the electronic device 30 can be placed at a distance allowing power to be transmitted reliably, and the power transmission can be made more efficiently.

### [First Example of Constitution of Charging Device Having Charging Stand]

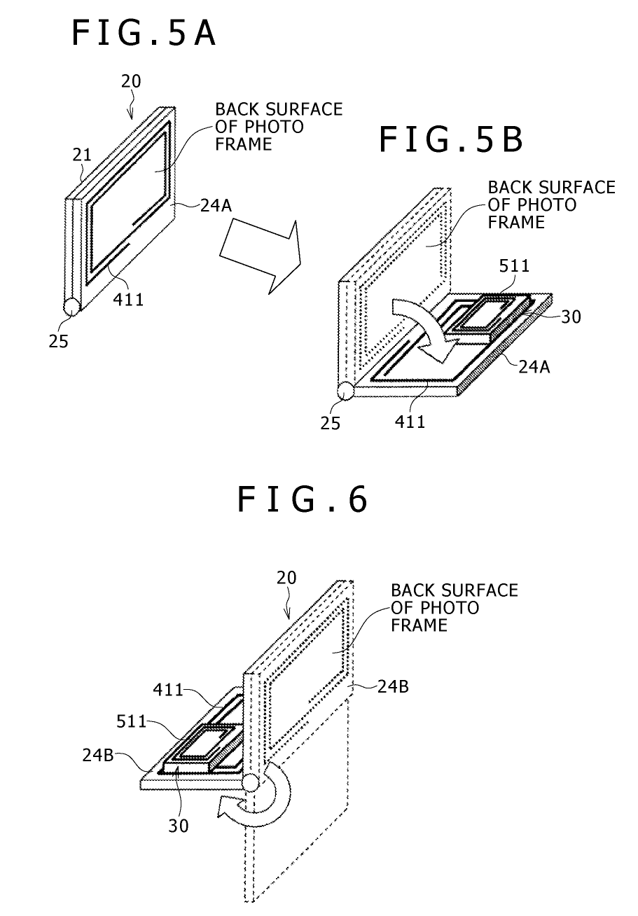

FIGS. 5A and 5B are diagrams showing a first example of constitution of the charging device having the charging stand in which the power transmitting coil according to the present embodiment is disposed and on which the electronic device can be placed.

In this example, the charging stand 24A is coupled to a rectangular casing 21 as the main body of a photo frame such that the charging stand 24A can be opened and closed by a hinge 25.

The feeding device 40 including the resonance coil (power transmitting coil) 411 is disposed inside the charging stand 24A.

The charging stand 24A for example has substantially the same size as the rectangular casing 21. When the charging stand 24A is not used, as shown in FIG. 5A, the charging stand 24A is retracted (housed) so as to be joined to the back surface side of the casing 21.

When the charging stand 24A is used, as shown in FIG. 5B, the charging stand 24A is unfolded on a desk or the like in a state of being opened to the rear of the photo frame.

The electronic device 30 is mounted on the charging stand 24A in the opened state. Thereby, the electronic device 30 can be placed at a distance allowing power to be transmitted reliably, and the power transmission can be made more efficiently.

### [Second Example of Constitution of Charging Device Having Charging Stand]

FIG. 6 is a diagram showing a second example of constitution of the charging device having the charging stand in which the power transmitting coil according to the present embodiment is disposed and on which the electronic device can be placed.

The charging stand 24B in the second example of constitution is different from the first example of constitution in that the charging stand 24B is not only unfolded in a state of being opened to the rear of the photo frame but also formed so as to be able to be unfolded to the front surface side of the photo frame when the charging stand 24B is used.

The second example of constitution is otherwise similar to the first example of constitution.

### [Third Example of Constitution of Charging Device Having Charging Stand]

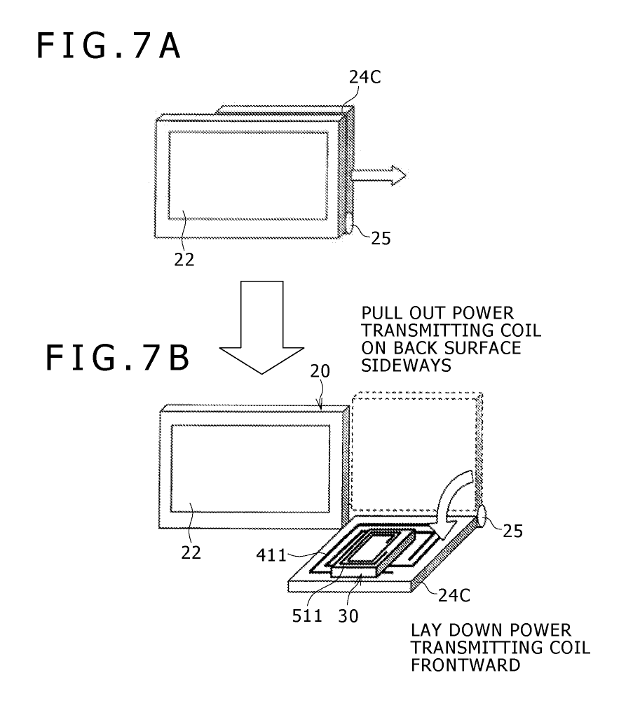

FIGS. 7A and 7B are diagrams showing a third example of constitution of the charging device having the charging stand in which the power transmitting coil according to the present embodiment is disposed and on which the electronic device can be placed.

In the third example of constitution, a hinge 25 is provided with such a constitution as to be able to be pulled out sideways, and the charging stand 24C housed on the back surface side of the photo frame is formed so as to be able to be pulled out sideways (horizontally) and unfolded also on a front surface side by being laid down on the front surface side in a state of being pulled out.

### [Fourth Example of Constitution of Charging Device Having Charging Stand]

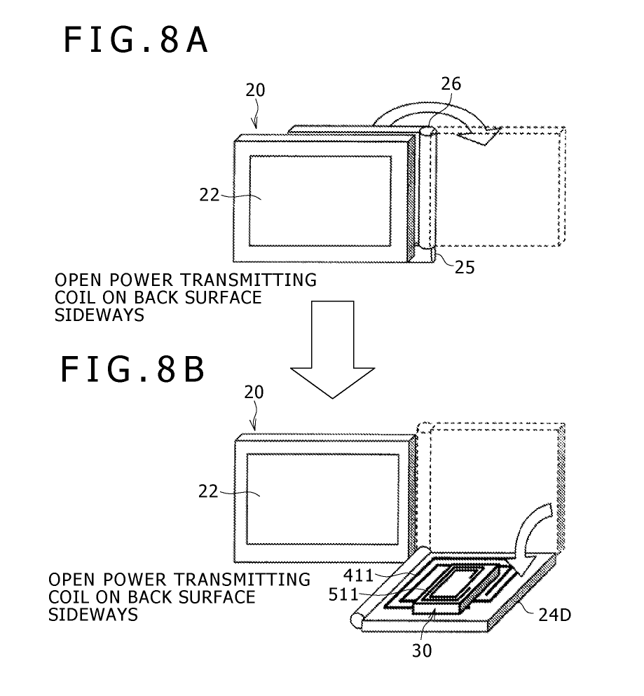

FIGS. 8A and 8B are diagrams showing a fourth example of constitution of the charging device having the charging stand in which the power transmitting coil according to the present embodiment is disposed and on which the electronic device can be placed.

In the fourth example of constitution, a hinge 26 that opens sideways is provided, and the charging stand 24D housed on the back surface side of the photo frame is formed so as to be able to be opened sideways (horizontally) and unfolded also on a front surface side by being laid down on the front surface side in a state of being opened.

### [Fifth Example of Constitution of Charging Device Having Charging Stand]

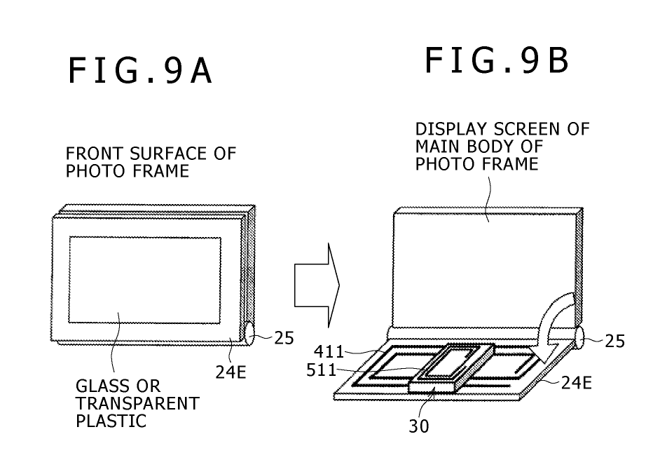

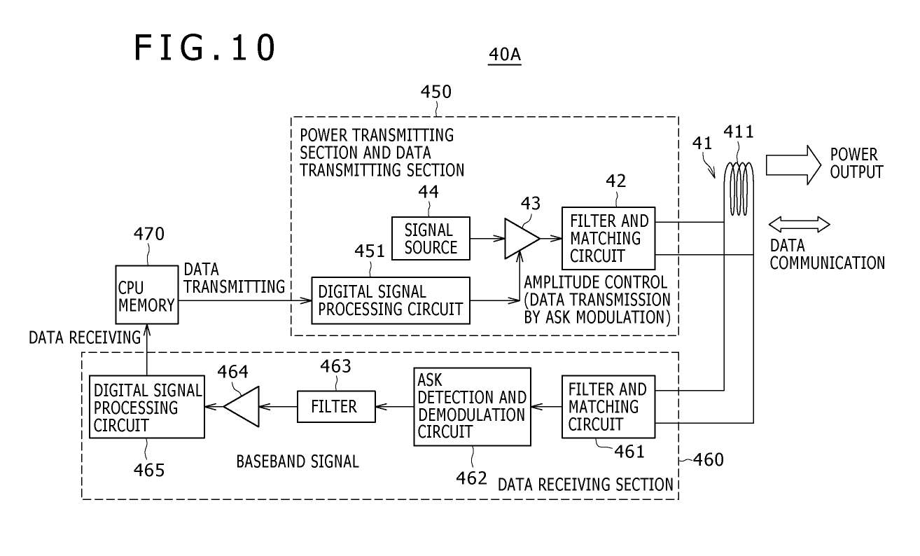

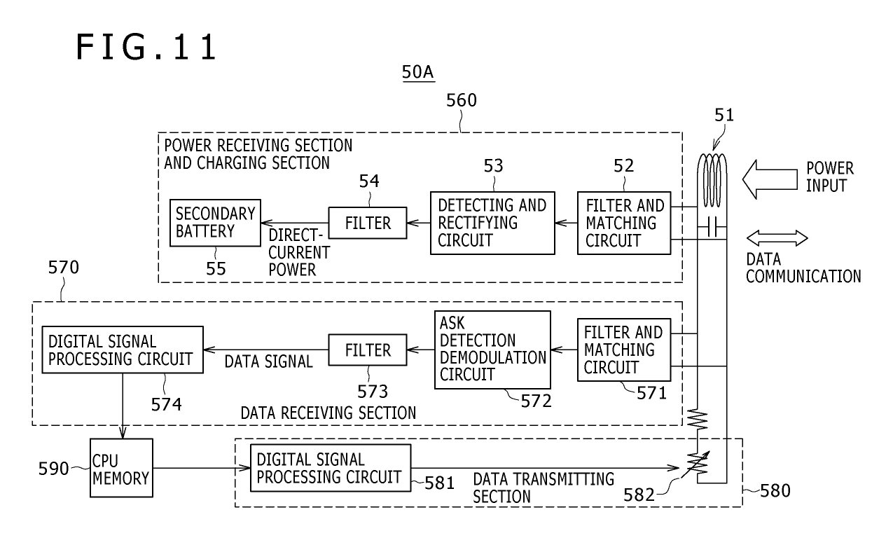

FIGS. 9A and 9B are diagrams showing a fifth example of constitution of the charging device having the charging stand in which the power transmitting coil according to the present embodiment is disposed and on which the electronic device can be placed.

In the fifth example of constitution, the charging stand 24E is formed by glass or transparent resin, and is formed so as to be able to be retracted on the front surface side of the photo frame by a hinge 25 and unfolded also on the front surface side by being laid down on the front surface side when used.

### <6. Example of Constitution of Feeding Device and Power Receiving Device of Wireless Charging System Performing Authentication>

The basic constitution and operation of the wireless charging system according to the present embodiment have been described above.

Description will next be made of the wireless charging system that has a communicating function and which performs charging and data transfer after authentication.

Authentication is performed by the communicating function using an authentication command to determine whether the charging device 20 formed by the photo frame and the electronic device 30 formed by a digital camera or the like may perform communication and data transfer, and thereafter charging and data transfer are performed.

In order to perform charging and data transfer, a data communicating system can use a different frequency band from that of a power transmission system, and use a communication system such as Bluetooth, ZigBee, a wireless LAN or the like as described above.

On the other hand, it is possible to use a communicating system such as applying modulation to the frequency of power transmission. Description in the following will be made of a constitution in which a resonant circuit is shared by the power transmission system and the communicating system.

FIG. 10 is a diagram showing an example of configuration of the feeding device of the charging device having a feeding function and a data transmitting and receiving function according to the present embodiment.

FIG. 11 is a diagram showing an example of configuration of the power receiving device of the electronic device having a power receiving function and a data transmitting and receiving function according to the present embodiment.

The feeding device 40A in FIG. 10 basically includes the configuration of FIG. 2, that is, a power transmitting element section 41, a filter and matching circuit 42, an amplifier 43, and a signal source 44 for generating high-frequency power as a power generating section.

The filter and matching circuit 42, the amplifier 43, the signal source 44, and a digital signal processing circuit 451 form a power transmitting and data transmitting section 450.

The feeding device 40A further includes a data receiving section 460 and a CPU 470 as a control section. The data receiving section 460 and the CPU 470 form a first wireless communicating section.

The data receiving section 460 has a filter and matching circuit 461, an ASK (Amplitude Shift Keying) detecting and demodulating circuit 462, a filter 463, an amplifier 464, and a digital signal processing circuit 465.

In the feeding device 40A in FIG. 10, a resonant circuit including the resonance coil (power transmitting coil) 411 and the capacitor 412 of the power transmitting element section 41 is shared by the power transmitting and data transmitting section 450 and the data receiving section 460.

In addition, the CPU 470 performs predetermined processing on the basis of data received by the data receiving section 460 and processed by the digital signal processing circuit 465, and controls the digital signal processing circuit 451 in the power transmitting and data transmitting section 450 for data transmission.

The power receiving device 50A in FIG. 11 basically includes the configuration of FIG. 3, that is, a power receiving element section 51, a filter and matching circuit 52, a detecting and rectifying circuit 53, a filter 54, and a battery 55 as a load.

The filter and matching circuit 52, the detecting and rectifying circuit 53, the filter 54, and the battery 55 as a load form a power receiving section 560.

The power receiving device 50A further includes a data receiving section 570, a data transmitting section 580, and a CPU 590 as a control section. The data receiving section 570, the data transmitting section 580, and the CPU 590 form a second wireless communicating section.

The data receiving section 570 has a filter and matching circuit 571, an ASK detecting and demodulating circuit 572, a filter 573, and a digital signal processing circuit 574.

The data transmitting section 580 includes a digital signal processing circuit 581 and a load switch 582.

In the power receiving device 50A in FIG. 11, a resonant circuit including the resonance coil (power receiving coil) 511 and the capacitor 512 of the power receiving element section 51 is shared by the power receiving section 560, the data receiving section 570, and the data transmitting section 580.

In addition, the CPU 590 performs processing on the basis of data received by the data receiving section 570 and processed by the digital signal processing circuit 574, and controls the digital signal processing circuit 581 in the data transmitting section 580 for data transmission.

In the wireless charging system 10 according to the present embodiment, the following processing is performed when the charging device 20 formed by the photo frame performs amplitude modulation (ASK modulation) while transmitting power, for example.

For example, as shown in FIG. 10, by changing the output of the amplifier 43 in the power transmitting and data transmitting section 450 under control of the CPU 470, an alternating-current magnetic field to be output is amplitude-modulated, and thus data can be transmitted to the electronic device 30 such as a digital camera or the like. An authentication command can therefore be transmitted from the charging device 20 formed by the photo frame to the electronic device 30.

In the power receiving device 50A of the electronic device 30, the amplitude modulation of the alternating-current magnetic field is detected and demodulated by the ASK detecting and demodulating circuit 572 in the data receiving section 570, processed by the digital signal processing circuit 574, and recognized as the authentication command by the CPU 590.

Receiving the authentication command, the power receiving device 50A of the electronic device 30 sends a reply to the charging device 20 formed by the photo frame by switching a load resistance 582 connected to the coil in the data transmitting section 580.

As the reply to the authentication command, for example an ID number written in advance on the side of the electronic device 30 and status information indicating a rechargeable state are returned.

The resonance coil 411 of the charging device 20 is magnetically coupled to the resonance coil 511 on the side of the electronic device 30. Therefore, an impedance change produced by the load switching of the data transmitting section 580 in the power receiving device is received as an amplitude change on the side of the charging device 20 as the photo frame, subjected to ASK detection and baseband demodulation in the data receiving section 460, and recognized as the reply by the CPU 470.

Thus, the feeding device 40A of the charging device 20 as the photo frame obtains the ID number of the electronic device 30, thereby verifies that the electronic device 30 is a legitimate device at the other end, and thereafter starts transmitting power for charging. Alternatively, after it is verified that the electronic device 30 is a legitimate device at the other end, image data is transferred to the photo frame, and displayed on the display device 22 including a photo frame screen.

<7. Operation of Wireless Charging System when Performing Authentication and Charging>

Description will next be made of an operation of the wireless charging system when performing authentication and charging.

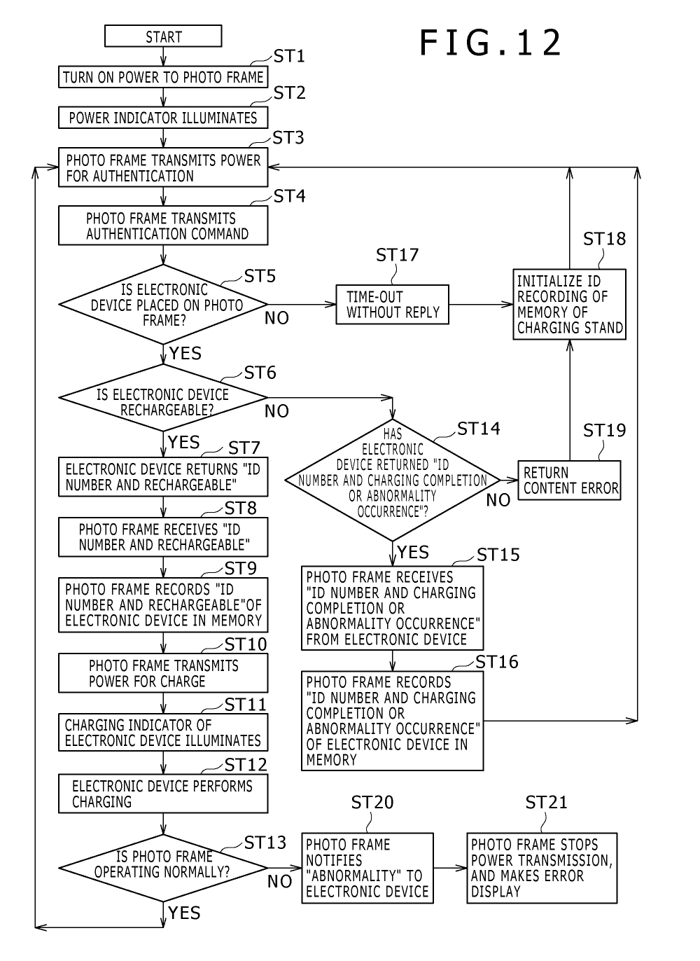

FIG. 12 is a flowchart of assistance in explaining an operation of the wireless charging system when performing authentication and charging.

In the following, the charging device will be described as the photo frame identified by a reference numeral 200.

First, the charging function of the photo frame 200 as the charging device 20 is switched on (ST1).

A power indicator for charging of the photo frame 200 thereby illuminates (ST2).

The photo frame 200 starts output for communication (ST3).

The photo frame 200 repeatedly transmits an authentication command (ST4), and waits for the electronic device 30 such as a digital camera or the like to be placed on the charging stand 24, for example.

In this case, the electronic device 30 as a digital camera, for example, is mounted on the charging stand 24 (ST5).

The electronic device 30 recognizes the authentication command (ST6).

The electronic device 30 returns an “ID number and rechargeable” (ST7).

The photo frame 200 receives the “ID number and rechargeable” (ST8), and records the received “ID number and rechargeable” in a memory (ST9).

The photo frame 200 next transmits power for charging (ST10).

The electronic device 30 starts charging, and turns on a charging indicator (ST11 and ST12).

The photo frame 200 periodically transmits the authentication command (ST13).

The electronic device 30 returns the “ID number and rechargeable” when normal charging is performed.

The photo frame 200 continues transmitting power for charging when receiving the legitimate “ID number and rechargeable.”

When an abnormality occurs in step ST6, the electronic device 30 returns an “ID number and abnormality occurrence” (ST14).

When the photo frame 200 receives the “ID number and abnormality occurrence” (ST15 and ST16), the photo frame 200 returns to step ST3 to repeatedly transmit the authentication command.

When charging is completed, the electronic device 30 returns an “ID number and charging completion.”

When the photo frame 200 receives the “ID number and charging completion,” the photo frame 200 repeats the transmission of the authentication command.

When the photo frame 200 receives no reply from the electronic device 30, the photo frame 200 determines that there is no digital camera, and deletes the “ID number” from the memory (ST18). In addition, when the electronic device 30 makes no reply in step ST14, the electronic device 30 displays a return content error, and proceeds to the process of step ST18 (ST19).

The photo frame 200 repeatedly transmits the authentication command.

When an abnormality occurs in the photo frame 200 itself, the photo frame 200 notifies the occurrence of the abnormality to the electronic device 30 (ST20), and the electronic device 30 stops charging.

Further, the photo frame 200 completely stops power transmission and communication, and makes error display (ST21).

Incidentally, an electronic book reader (electronic book terminal), a notebook PC, a tablet PC or the like can also be charged on a noncontact basis, and transfer image data and the like simultaneously and in parallel with the charging.

Even when the electronic book reader or the like is in a protective case, charging and communication can be performed by merely putting down the electronic book reader or the like as it is.

### <8. Example of Display of State of Battery Charge in Charging Object Device on Charging Device Side>

The above description has been made of the transmission and reception of the authentication command and the like.

Description in the following will be made of an example in which according to another command, information such as the progress of charging of a battery in the electronic device 30 such as a digital camera or the like in percentage terms (charging rate), full charge and hence charging completion, a time remaining until full charge, and the like can also be communicated, and displayed on the display device 22 of the charging device 20 formed by the photo frame.

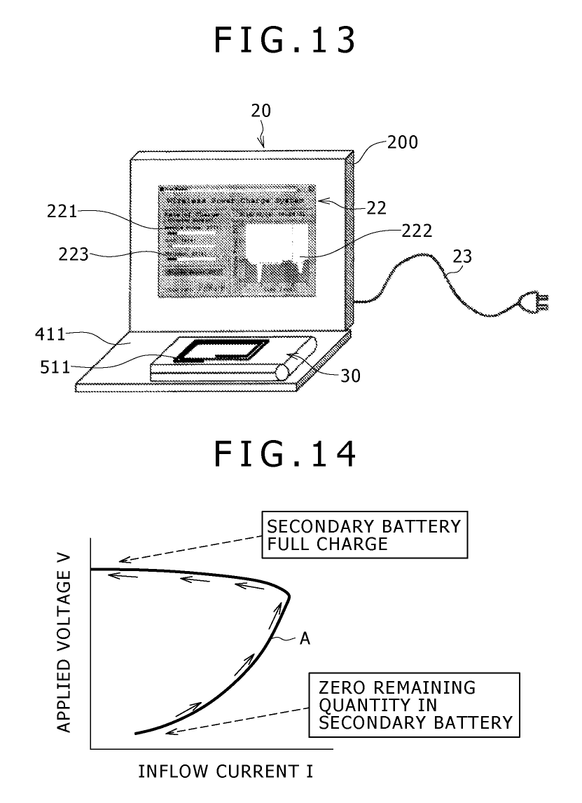

FIG. 13 is a diagram showing an example of display of a state of charge of the electronic device as a charging object on the display screen of the photo frame as an example of the charging device.

The example of FIG. 13 illustrates a display region 221 showing a present charging rate (%) of the electronic device 30 and a display region 222 showing temporal changes in charging power (W) from the power transmitting coil.

For this displayed information, as will be described later, information such as the charging rate and the like detected within the electronic device 30 can be transferred to the charging device 20 formed by the photo frame 200 by the above-described wireless communication. The transferred information can be displayed as information for monitoring present conditions of charge on the screen of the photo frame.

In addition, transmission power on the power transmitting side of the photo frame can be monitored on the screen.

In addition, a time remaining until full charge can be displayed in another display region 223.

### <9. Mechanism for Displaying Charging Conditions on Screen of Photo Frame as Example of Charging Device>

Description will next be made of a mechanism for displaying charging conditions on the screen of the photo frame as an example of the charging device.

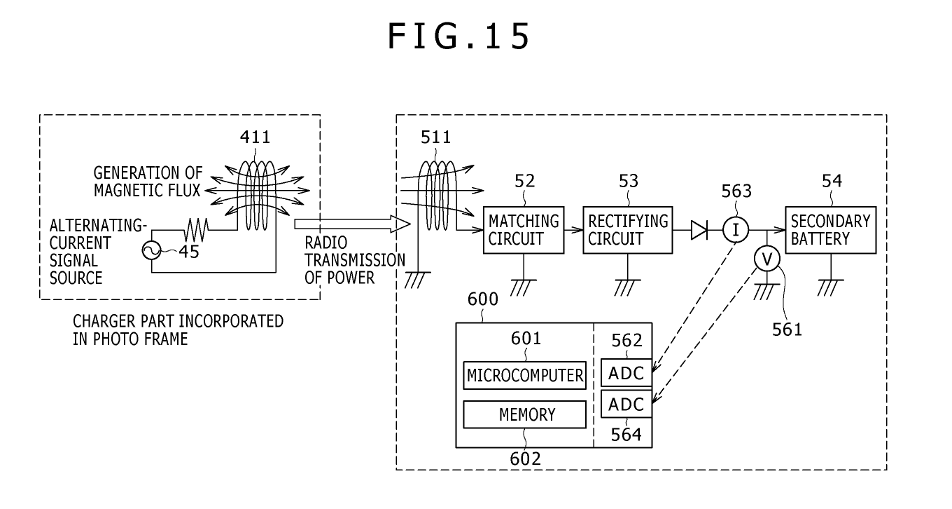

FIG. 14 is a diagram showing a voltage-current characteristic at a time of charging of a battery (secondary battery).

In FIG. 14, an axis of abscissas indicates inflow current I, and an axis of ordinates indicates applied voltage V.

FIG. 15 is a diagram showing a system for detecting the voltage and the current at a time of charging of the battery (secondary battery) in the power receiving device.

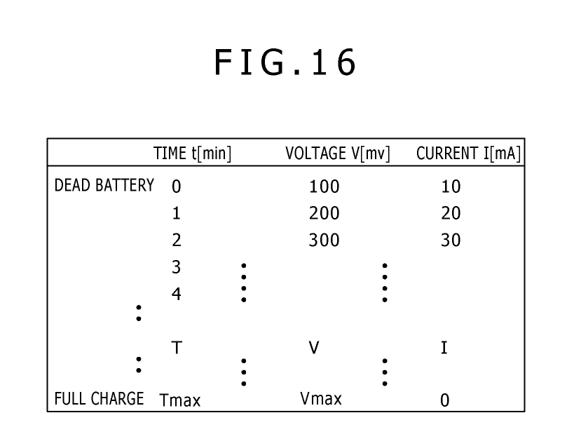

FIG. 16 is a diagram showing a known charging characteristic recorded in a memory on the side of the electronic device as a table.

When the battery (secondary battery) of the electronic device 30 such as a digital camera, a portable telephone or the like is charged on a noncontact basis, it is convenient to display a present charging rate and a time remaining until full charge on the screen of the photo frame and visually check the present charging rate and the time remaining until full charge.

A relation between the applied voltage V and the inflow current I when the battery (secondary battery) is charged is a characteristic referred to as a fold-back type drooping characteristic A.

When the battery (secondary battery) starts being charged in a state close to a zero remaining quantity, the battery can be charged even when the applied voltage V is low, and a current flows into the battery.

The terminal voltage of the battery (secondary battery) rises with the passage of charging time. As the charging progresses to a certain extent, the current does not flow into the battery even when the applied voltage V is raised, so that the battery is fully charged.

This fold-back type drooping characteristic A is a characteristic curve specific to the product of the secondary battery. Thus, the fold-back type drooping characteristic A is a known curve when the model number of the secondary battery is determined.

Hence, when the voltage value V and the current value I are detected during charging, it is possible to determine to what extent the present charging has progressed and a time remaining until full charge from the known curve.

Accordingly, the relation between the time T, the voltage V, and the current I of the fold-back type drooping characteristic A is recorded in advance in the memory of the electronic device 30 such as a digital camera, a portable telephone or the like as digital data (discrete values) in the form of (T, V, I), as shown in FIG. 16.

In order to detect the present voltage value V and the present current value I, as shown in FIG. 15, the voltage value V detected by a voltmeter 561 at the charging terminal of the battery (secondary battery) 55 is subjected to AD conversion by an AD converter (ADC) 562, and then captured into a digital circuit 600.

As for the current value I, a current is passed through an ammeter 563, for example a low resistance R of a few ohms to about 10 ohms, and a potential difference ΔV across the resistance R is subjected to AD conversion by an ADC 564, and then captured into the digital circuit 600. The current value I is obtained by calculation from I=ΔV/R.

The digital circuit 600 includes a microcomputer (micon) 601 and a memory 602. The microcomputer 601 performs calculation and the like.

A known charging characteristic from a dead state to full charge is recorded in the memory 602.

On the other hand, the microcomputer 601 compares the present voltage value V and the present current value I, determines closest values, and obtains a time T corresponding to the closest values.

A time remaining until full charge is calculated when the time T is subtracted from a time Tmax of full charge of the charging characteristic.

In addition, a charging rate is calculated as a ratio V/Vmax of the present voltage V to a voltage Vmax at a time of full charge.

The voltmeter 561, the ammeter 563, the ADCs 562 and 564, the microcomputer 601, and the memory 602 form an information obtaining section.

### <10. Operation of Displaying Charging Conditions>

Description will next be made of an operation of displaying charging conditions.

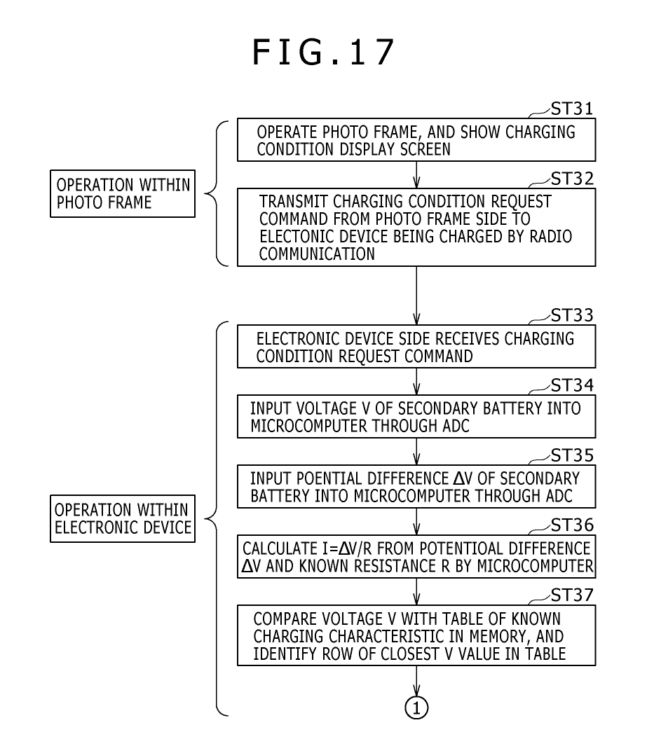

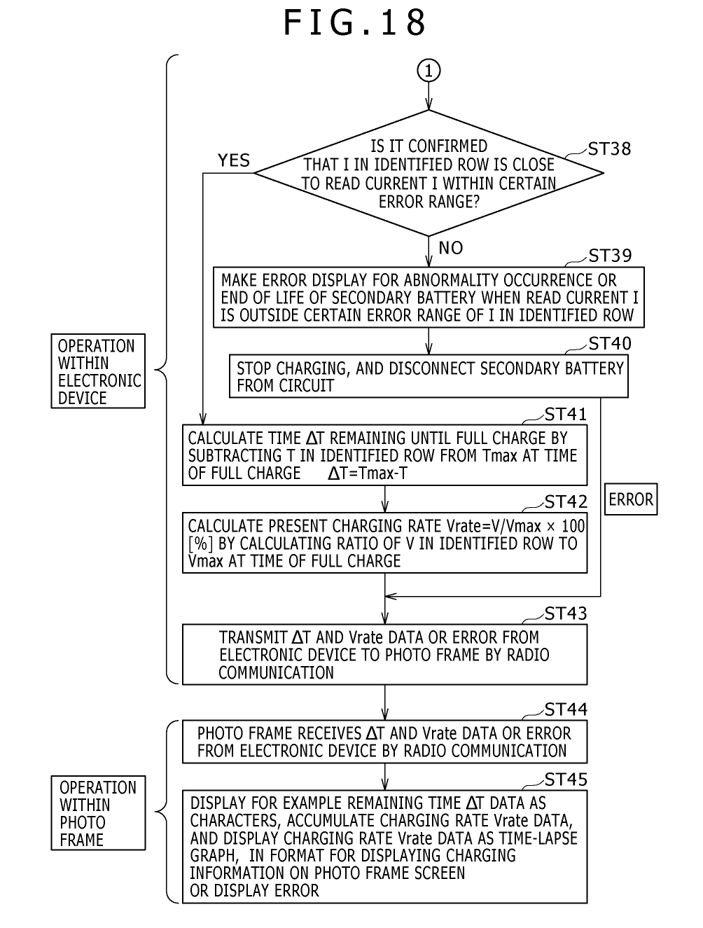

FIG. 17 and FIG. 18 are a flowchart of assistance in explaining an operation of displaying charging conditions.

For example, the user operates the photo frame 200 to switch to a “charging condition display screen” (ST31).

Then, a charging condition request command is transmitted from the photo frame 200 to the electronic device 30 currently being charged by wireless (radio) communication (ST32).

When the electronic device 30 is not present on the charging stand 24, for example, no wireless response is returned, and thus photo frame display is “device being charged: none.”

When the electronic device 30 is being charged, the charging condition request command is received (ST33), and information inside the electronic device 30 is collected (ST34 to ST37).

Specifically, the terminal voltage V of the battery (secondary battery) 55 and the potential difference ΔV of the known resistance R are subjected to AD conversion and captured into the microcomputer (micon) 601 (ST34 and ST35).

The microcomputer 601 calculates Current I=ΔV/R (ST36). Then, the microcomputer 601 identifies a row having a voltage close to the voltage V referring to the charging characteristic table recorded in the memory 602 (ST37). The microcomputer 601 checks that I in this row is in a certain error range of the calculated current I (ST38).

When the current I is outside the range, it is determined that an abnormality or a degradation of the battery (secondary battery) is detected. A charging error display is made on the main body of the electronic device 30 (ST39), for example charging is stopped, and the battery (secondary battery) is disconnected from a circuit (ST40).

When the microcomputer 601 determines that the current I in the identified row is in the certain error range of the calculated current I (ST38), on the other hand, the microcomputer 601 calculates a difference ΔT between a time T in the row identified in the list and the full charge time Tmax (ST41).

The microcomputer 601 calculates the ratio Vrate of the present voltage V to the full charge voltage Vmax as a charging rate (ST42).

Then, the difference ΔT and the ratio Vrate are transmitted from the electronic device 30 to the photo frame 200 by wireless (radio) communication (ST43). Alternatively, error information is transmitted.

The photo frame 200 receives the return data on a wireless (radio) basis (ST44), and displays the remaining time ΔT and the ratio Vrate as charging rate in the display regions 223 and 221 on the screen of the display device 22 (ST45).

In addition, charging rate data is accumulated, and displayed as a time-lapse graph in the display region 222. Alternatively, an error occurrence is displayed.

Thus, according to the present embodiment, when the battery (secondary battery) of the electronic device 30 such as a digital camera, a portable telephone or the like is charged on a noncontact basis, the present charging rate and the time remaining until full charge can be displayed on the screen of the photo frame, and checked visually.

Thereby, a highly convenient wireless charging system is provided for the user.

The present disclosure contains subject matter related to that disclosed in Japanese Priority Patent Application JP 2010-157183 filed in the Japan Patent Office on Jul. 9, 2010, the entire content of which is hereby incorporated by reference.

It should be understood by those skilled in the art that various modifications, combinations, sub-combinations and alternations may occur depending on design requirements and other factors insofar as they are within the scope of the appended claims or the equivalent thereof.

What is claimed is:

1. A wireless charging device comprising:
a feeding device capable of feeding power on a wireless basis; and
a display device,
said feeding device including
a power generating section configured to generate the power to be fed,
a power transmitting element section configured to transmit the power generated by said power generating section, and
a wireless communicating section capable of wireless data transmission and reception, and
said display device being capable of displaying at least one of data transferred from a charging object device and received through said wireless communicating section and information on charging conditions, the information on the charging conditions being received as a response to the power transmitted for charging.

2. The wireless charging device according to claim 1, wherein the information on said charging conditions includes at least one of a time remaining until full charge and a present charging rate.

3. The wireless charging device according to claim 1, wherein
said power transmitting element section has a resonant circuit including a resonance coil, and
said resonant circuit is shared by a power transmitting section configured to transmit the power and said wireless communicating section.

4. The wireless charging device according to claim 1, wherein
said power transmitting element section includes a resonance coil for transmitting the power,
the wireless charging device further includes
a device main body including said display device, and
a charging stand capable of assuming a retracted state of being folded up on said device main body and an unfolded state, and
at least the resonance coil of said power transmitting element section among said power generating section, said power transmitting element section, and said wireless communicating section of said feeding device is disposed in said charging stand.

5. A wireless charging system comprising:
a wireless charging device capable of transmitting power for charging on a wireless basis; and
an electronic device including a battery and a power receiving device, the power receiving device being capable of receiving the power of said wireless charging device and charging said battery,
said wireless charging device including
a feeding device capable of feeding the power on a wireless basis and
a display device,
said feeding device including
a power generating section configured to generate the power to be fed,
a power transmitting element section configured to transmit the power generated by said power generating section, and
a first wireless communicating section capable of wireless data transmission and reception to and from said electronic device,
said power transmitting element section including a first resonance coil for transmitting the power,
said display device being capable of displaying at least one of data transferred from the electronic device and received through said first wireless communicating section and information on charging conditions, the information on the charging conditions being received as a response to the power transmitted for charging, and
the power receiving device of said electronic device including
a power receiving element section including a second resonance coil for receiving the power while having a magnetic field resonance relation to said first resonance coil of said feeding device,
an information obtaining section configured to obtain the information on said charging conditions, and
a second wireless communicating section capable of wireless data transmission and reception to and from said wireless charging device, and capable of transmitting the information on the charging conditions, the information on the charging conditions being obtained by said information obtaining section, on a wireless basis as the response to the power received for charging from said wireless charging device.

6. The wireless charging system according to claim 5, wherein the information on said charging conditions includes at least one of a time remaining until full charge and a present charging rate.

7. The wireless charging system according to claim 5, wherein
said power transmitting element section has a first resonant circuit including a first resonance coil, and
said first resonant circuit is shared by a power transmitting section configured to transmit the power and said first wireless communicating section.

8. The wireless charging system according to claim 5, wherein
said power receiving element section has a second resonant circuit including a second resonance coil, and
said second resonant circuit is shared by a power receiving section configured to receive the power and said second wireless communicating section.

9. The wireless charging system according to claim 5, wherein
said wireless charging device includes
a device main body including said display device, and
a charging stand capable of assuming a retracted state of being folded up on said device main body and an unfolded state, and
at least the first resonance coil of said power transmitting element section among said power generating section, said power transmitting element section, and said first wireless communicating section of said feeding device is disposed in said charging stand.
